(19) United States
(12) Patent Application Publication
(10) Pub. No.: US 2026/0304449 A1
(43) Pub. Date: Oct. 1, 2026

(54) INCREASED NR SL SCI2 ROBUSTNESS

(71) Applicant: QUALCOMM Incorporated, San Diego, CA (US)

(72) Inventors: Guy SPIEGELSTEIN, Nes-Ziona (IL); Ran BERLINER, Kfar Aviv (IL); Moshe BEN-ARI, Rehovot (IL); Amit BAR-OR TILLINGER, Tel-Aviv (IL); Shay LANDIS, Hod Hasharon (IL); Tal OVED, Modiin (IL); Eitan YERUSHALMI, Tel Aviv (IL); Yehuda Shabtay BAREL, Kfar Saba (IL); Daniel HOROVITZ, Kiryat Tivon (IL)

(21) Appl. No.: 19/097,318

(22) Filed: Apr. 1, 2025

(51) Int. Cl. H04W 72/25; H04L 5/00; H04L 25/02

(52) U.S. Cl. CPC H04W 72/25; H04L 5/0005; H04L 25/0202

(57) ABSTRACT

Various aspects of the present disclosure generally relate to wireless communication. In some aspects, a user equipment (UE) may receive a SCI2 indicating resource mapping for a PSSCH transmission. The UE may also identify a first DMRS symbol associated with the received PSSCH transmission. The UE may further de-map the SCI2 starting from the first DMRS symbol per RB. The UE may then skip one or more RBs in the SCI2 mapping, wherein the skipped RBs are identified as those subject to channel estimation impairments due to extrapolation. Numerous other aspects are provided.

### TECHNICAL FIELD

Aspects of the present disclosure relate generally to wireless communication systems, and more particularly, to a wireless communication system between a plurality of user equipment (UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, Cyclic Prefix-Orthogonal Frequency Division Multiplexing (CP-OFDM), and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), Sidelink, Device-to-Device (D2D), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method of wireless communication at a user equipment (UE) using Sidelink or D2D, comprising receiving a Sidelink Control Information 2 (SCI2) indicating resource mapping for a Physical Sidelink Shared Channel (PSSCH) transmission. The method also includes identifying a first transmitting Demodulation Reference Signal (DMRS) symbol associated with the received PSSCH transmission. Additionally, the method further includes de-mapping the SCI2 starting from the first transmitted DMRS symbol per resource block. Additionally, the method further includes skipping one or more RBs in the SCI2 mapping, wherein the skipped RBs are identified as those subject to channel estimation impairments due to extrapolation.

An example aspect includes a method of wireless communication at a user equipment (UE), comprising generating a Sidelink Control Information 2 (SCI2) indicating resource mapping for a Physical Sidelink Shared Channel (PSSCH) transmission. The method further includes determining a first transmitting Demodulation Reference Signal (DMRS) symbol associated with the PSSCH transmission. Additionally, the method further includes mapping the SCI2 starting from the first transmitted DMRS symbol per resource block for the transmission. Additionally, the method further includes skipping one or more RBs in the SCI2 mapping, wherein the skipped RBs are identified as those subject to channel estimation impairments due to extrapolation.

Another example aspect includes an apparatus for wireless communication at a user equipment (UE), comprising one or more memories and one or more processors coupled with one or more memories and configured to perform, individually or in any combination, the follow actions. The one or more processors are configured to receive a Sidelink Control Information 2 (SCI2) indicating resource mapping for a Physical Sidelink Shared Channel (PSSCH) transmission. The one or more processors are further configured to identify a first transmitting Demodulation Reference Signal (DMRS) symbol associated with the received PSSCH transmission. Additionally, the one or more processors are further configured to de-map the SCI2 starting from the first transmitted DMRS symbol per resource block. Additionally, the one or more processors are further configured to skip one or more RBs in the SCI2 mapping, wherein the skipped RBs are identified as those subject to channel estimation impairments due to extrapolation.

Another example aspect includes an apparatus for wireless communication at a user equipment (UE), comprising one or more memories and one or more processors coupled with one or more memories and configured to perform, individually or in any combination, the follow actions. The one or more processors are configured to generate a Sidelink Control Information 2 (SCI2) indicating resource mapping for a Physical Sidelink Shared Channel (PSSCH) transmission. The one or more processors are further configured to determine a first transmitting Demodulation Reference Signal (DMRS) symbol associated with the PSSCH transmission. Additionally, the one or more processors are further configured to map the SCI2 starting from the first transmitted DMRS symbol per resource block for the transmission. Additionally, the one or more processors are further configured to skip one or more RBs in the SCI2 mapping, wherein the skipped RBs are identified as those subject to channel estimation impairments due to extrapolation.

Another example aspect includes an apparatus for wireless communication at a user equipment (UE), comprising means for receiving a Sidelink Control Information 2 (SCI2) indicating resource mapping for a Physical Sidelink Shared Channel (PSSCH) transmission. The apparatus further includes means for identifying a first transmitting Demodulation Reference Signal (DMRS) symbol associated with the received PSSCH transmission. Additionally, the apparatus further includes means for de-mapping the SCI2 starting from the first transmitted DMRS symbol per resource block. Additionally, the apparatus further includes means for skipping one or more RBs in the SCI2 mapping, wherein the skipped RBs are identified as those subject to channel estimation impairments due to extrapolation.

Another example aspect includes an apparatus for wireless communication at a user equipment (UE), comprising means for generating a Sidelink Control Information 2 (SCI2) indicating resource mapping for a Physical Sidelink Shared Channel (PSSCH) transmission. The apparatus further includes means for determining a first transmitting Demodulation Reference Signal (DMRS) symbol associated with the PSSCH transmission. Additionally, the apparatus further includes means for mapping the SCI2 starting from the first transmitted DMRS symbol per resource block for the transmission. Additionally, the apparatus further includes means for mapping the SCI2 starting from the first transmitted DMRS symbol per resource block for the transmission. Additionally, the apparatus includes means for skipping one or more RBs in the SCI2 mapping, wherein the skipped RBs are identified as those subject to channel estimation impairments due to extrapolation.

Another example aspect includes a computer-readable medium comprising stored instructions for wireless communication at a user equipment (UE), wherein the instructions are executable by one or more processors to receive a Sidelink Control Information 2 (SCI2) indicating resource mapping for a Physical Sidelink Shared Channel (PSSCH) transmission. The instructions are further executable to identify a first transmitting Demodulation Reference Signal (DMRS) symbol associated with the received PSSCH transmission. Additionally, the instructions are further executable to de-map the SCI2 starting from the first transmitted DMRS symbol per resource block. Additionally, the instructions are further executable to skip one or more RBs in the SCI2 mapping, wherein the skipped RBs are identified as those subject to channel estimation impairments due to extrapolation.

Another example aspect includes a computer-readable medium comprising stored instructions for wireless communication at a network entity, wherein the instructions are executable by one or more processors to generate a Sidelink Control Information 2 (SCI2) indicating resource mapping for a Physical Sidelink Shared Channel (PSSCH) transmission. The instructions are further executable to determine a first transmitting Demodulation Reference Signal (DMRS) symbol associated with the PSSCH transmission. Additionally, the instructions are further executable to map the SCI2 starting from the first transmitted DMRS symbol per resource block for the transmission. Additionally, the instructions are further executable to skip one or more RBs in the SCI2 mapping, wherein the skipped RBs are identified as those subject to channel estimation impairments due to extrapolation.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1A is a diagram illustrating an example of a wireless communications system and an access network;

FIG. 1B is a conceptual diagram of an example Open Radio Access Network architecture;

FIG. 2A is a diagram illustrating an example of a first frame, in accordance with various aspects of the present disclosure;

FIG. 2B is a diagram illustrating an example of downlink channels within a subframe, in accordance with various aspects of the present disclosure;

FIG. 2C is a diagram illustrating an example of a second frame, in accordance with various aspects of the present disclosure;

FIG. 2D is a diagram illustrating an example of uplink channels within a subframe, in accordance with various aspects of the present disclosure;

FIG. 3 is a diagram illustrating an example of a protocol architecture of a network device and user equipment (UE) in an access network;

FIG. 4A illustrates a first configuration 400a (e.g., Configuration 2A) where the PSSCH allocation is larger than PSCCH configuration;

FIG. 4B illustrates a second configuration 400b (e.g., Configuration 2B) where PSSCH is spread over multiple SubChannels, irrespective of the PSCCH configuration;

FIG. 5A illustrates an example of suggested allocation mapping in the first configuration 400a;

FIG. 5B illustrates an example of suggested allocation mapping in the second configuration 400b;

FIG. 6 illustrates a table showing various parameter configurations where SCI2 extrapolation becomes problematic;

FIG. 7 is a flowchart of an example of a method of wireless communication at a Rx user device; and

FIG. 8 is a flowchart of an example of a method of wireless communication at a Tx user device;

FIG. 9 is a diagram illustrating an example of a hardware implementation for an apparatus employing a processing system; and

Like reference numbers and designations in the various drawings indicate like elements.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

In New Radio (NR) Sidelink (SL) communication, control data is essential for enabling direct device-to-device (D2D) communication without relying on a base station. This control data is distributed between two key channels: the Physical Sidelink Control Channel (PSCCH) and the Physical Sidelink Shared Channel (PSSCH). PSCCH is responsible for transmitting the first-stage Sidelink Control Information (SCI1), which contains critical information such as resource allocation details and scheduling assignments, allowing receiving devices to determine when and where to decode the subsequent data. On the other hand, PSSCH carries both the actual data payload and the second-stage Sidelink Control Information (SCI2). SCI2 provides additional details necessary for accurate data decoding, including modulation and coding schemes (MCS), redundancy versions, and hybrid automatic repeat request (HARQ) parameters. By embedding SCI2 within PSSCH, the system enhances resource efficiency and adaptive data transmissions, ensuring that sidelink communication remains reliable and effective across different network conditions. This two-stage control mechanism helps maintain reliable and efficient sidelink communication, ensuring that UEs can properly receive and decode data while adapting to different network environments.

SCI2 plays a crucial role in ensuring that the transmitted data reaches the intended receiving User Equipment (UE) and is correctly decoded. It carries essential control information that helps the receiving UE determine whether a particular transmission is meant for it and how to interpret the associated data. Since any errors in SCI2 decoding can lead to misinterpretation or loss of data, it must exhibit a higher level of robustness compared to the actual data being transmitted. To achieve this, SCI2 is designed with a lower and more manageable code rate, allowing for better error correction and increased reliability, even in challenging channel conditions such as interference, fading, or high mobility scenarios. A lower code rate ensures that SCI2 can be successfully decoded with minimal errors, even in cases where the main data transmission might be more susceptible to degradation. This robustness is critical for maintaining stable sidelink communication, enabling seamless coordination between UEs, and ensuring that the intended receiver can correctly reconstruct the transmitted message.

SCI2 can operate under three distinct configurations in the frequency domain, which directly influence its allocation in the time domain and overall transmission reliability. In Configuration 1: Equal Resource Allocation, the number of Resource Blocks (RBs) assigned to the Physical Sidelink Shared Channel (PSSCH) matches that of the Physical Sidelink Control Channel (PSCCH), ensuring a straightforward mapping of SCI2.

However, in Configuration 2: Unequal Resource Allocation, the PSSCH allocation exceeds the PSCCH configuration, leading to two possible sub-cases. In Configuration 2A, the SubChannel resource pool is larger than the PSCCH configuration within the same resource pool, causing potential channel estimation challenges. In Configuration 2B, the PSSCH allocation is spread across multiple SubChannels, regardless of the PSCCH configuration, which may further impact SCI2 decoding. These configurations dictate SCI2's position within the time-frequency domain, influencing its robustness and reliability. A well-structured design is essential to mitigate performance degradation, particularly in scenarios where channel estimation is challenging, ensuring accurate decoding and stable sidelink communication.

The problem in NR Sidelink (SL) communication arises from the way SCI2 is mapped onto PSSCH resources, directly impacting channel estimation accuracy and decoding reliability. SCI2 plays a critical role in ensuring that the transmitted data is properly interpreted by the receiving device, but its placement within the time-frequency domain can affect how well it can be decoded. In certain configurations, SCI2 mapping falls into regions where channel estimation relies on extrapolation rather than interpolation, leading to a decrease in decoding accuracy and an increase in transmission errors.

This issue becomes particularly problematic when the PSSCH allocation is larger than the PSCCH configuration, resulting in SCI2 being mapped onto suboptimal resource blocks (RBs). Two specific cases contribute to this problem. In Configuration 2A, the SubChannel resource pool is larger than the PSCCH configuration, meaning that SCI2 symbols may be placed in areas with insufficient channel estimation references. In Configuration 2B, the PSSCH allocation is spread across multiple SubChannels, leading to a scenario where SCI2 may be mapped into resource blocks that lack adequate Demodulation Reference Signal (DMRS) support. Without proper DMRS reference points, the receiving device struggles to accurately decode SCI2, making the entire sidelink communication process less reliable.

The impact of this issue is particularly severe in high-mobility or dynamic environments, where accurate channel estimation is already challenging. The improper placement of SCI2 leads to higher decoding failure rates, ultimately reducing the robustness of NR Sidelink communication. Since SCI2 determines how data is addressed and decoded, any errors in its transmission can disrupt data integrity and compromise overall network performance.

The root cause of this problem lies in the misalignment between SCI2 mapping and channel estimation capabilities. When SCI2 symbols are mapped onto resource blocks that require extrapolated channel estimation, the accuracy of decoding significantly decreases. This issue is further aggravated by resource allocation conflicts, where the relationship between PSCCH and PSSCH configurations determines whether SCI2 is placed in well-estimated or poorly-estimated regions.

To resolve this issue, a more robust SCI2 mapping strategy is required, ensuring that SCI2 symbols are placed in well-estimated resource blocks where interpolation-based channel estimation is feasible. Implementing such an approach would enhance SCI2 decoding performance, minimize transmission errors, and improve overall NR Sidelink communication reliability, particularly in challenging network conditions.

Accordingly, the present disclosure describes improving the robustness of SCI2 mapping in NR sidelink communication by addressing channel estimation challenges caused by suboptimal resource allocation. The present disclosure avoids mapping SCI2 to RBs requiring extrapolated channel estimation, ensuring it is placed in well-estimated regions with reliable interpolation. By dynamically adjusting SCI2 placement per RB, the present disclosure enhances decoding accuracy, reduces transmission errors, and improves overall sidelink performance.

The enhancements to SCI2 mapping in NR Sidelink communication provide significant technical benefits, primarily improving channel estimation accuracy, decoding robustness, and overall transmission reliability. By preventing excessive extrapolation, the new mapping strategy ensures that SCI2 symbols are placed in regions where interpolation-based estimation is feasible, reducing decoding errors and enhancing overall system stability. Additionally, all control symbols now rely on interpolation rather than extrapolation, making the decoding process more reliable even in challenging channel conditions. The approach also optimizes resource utilization without additional bandwidth or power consumption, as it simply remaps SCI2 symbols to better locations within the time-frequency domain.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

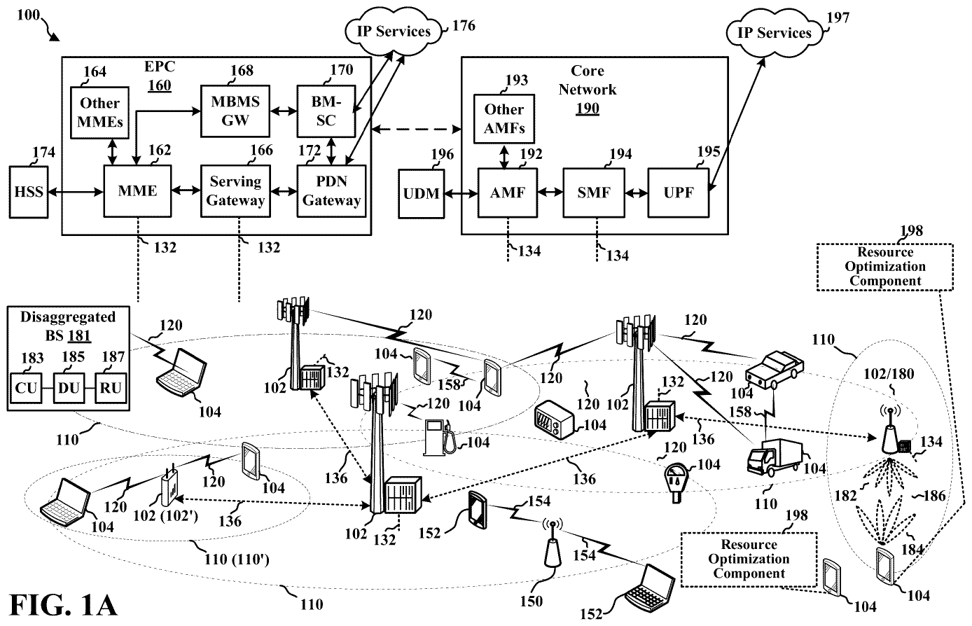

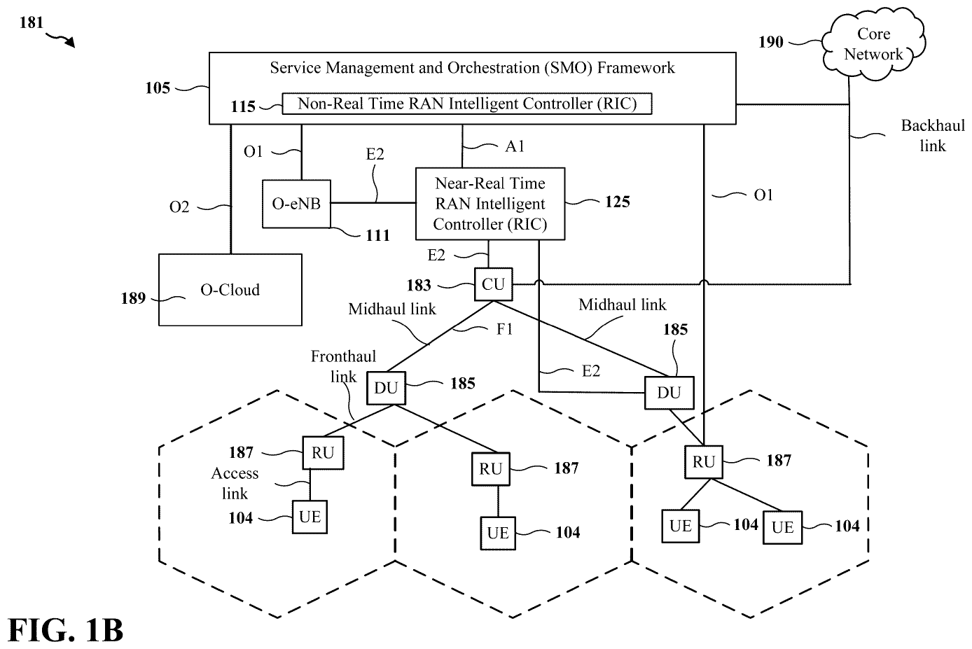

FIG. 1A is a diagram illustrating an example of a wireless communications system and an access network 100. The wireless communications system (also referred to as a wireless wide area network (WWAN)) includes network devices 102, UE(s) 104, an Evolved Packet Core (EPC) 160, and another core network 190 (e.g., a 5G Core (5GC)). The network devices 102 may include macrocells, such as high power cellular network devices, and/or small cells, such as low power cellular network devices(including femtocells, picocells, and microcells). In some aspects, the network device may include a base station (BS).

The network devices 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The network devices 102 configured for 5G New Radio (NR), which may be collectively referred to as the Next Generation Radio Access Network (RAN) (NG-RAN), may interface with a core network 190 through second backhaul links 134. In addition to other functions, the network devices 102 may perform one or more of: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the network devices 102 may communicate directly or indirectly (e.g., through the EPC 160 or core network 190) with each other over third backhaul links 136 (e.g., X2 interface). The first backhaul links 132, the second backhaul links 134, and the third backhaul links 136 may be wired, wireless, or some combination thereof. At least some of the network devices 102 may be configured for integrated access and backhaul (IAB). Accordingly, such network devices may wirelessly communicate with other network devices, which also may be configured for IAB.

At least some of the network devices 102 configured for IAB may have a split architecture including multiple units, some or all of which may be collocated or distributed and which may communicate with one another.

The network devices 102 may wirelessly communicate with the UEs 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.).

A UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Each of the network devices 102 may provide communication coverage for a respective geographic coverage area 110, which may also be referred to as a “cell.” Potentially, two or more geographic coverage areas 110 may at least partially overlap with one another, or one of the geographic coverage areas 110 may contain another of the geographic coverage areas. For example, the small cell 102′ may have a coverage area 110′ that overlaps with the coverage area 110 of one or more macro network devices 102. A network that includes both small cells and macrocells may be known as a heterogeneous network. A heterogeneous network may also include Home Evolved Node BS (eNBs) (HeNBs), which may provide service to a restricted group known as a closed subscriber group (CSG).

The communication links 120 between the network devices 102 and the UEs 104 may include uplink (also referred to as reverse link) transmissions from a UE 104 to a network device 102 and/or downlink (also referred to as forward link) transmissions from a network device 102 to a UE 104. The communication links 120 may use multiple-input and multiple-output (MIMO) antenna technology, including spatial multiplexing, beamforming, and/or transmit diversity. Wireless links or radio links may be on one or more carriers, or component carriers (CCs). The network devices 102 and/or UEs 104 may use spectrum up to Y megahertz (MHz) (e.g., Y may be equal to or approximately equal to 5, 10, 15, 20, 100, 400, etc.) bandwidth per carrier allocated in a carrier aggregation of up to a total of Yx MHz (e.g., x CCs) used for transmission in each direction. The CCs may or may not be adjacent to each other. Allocation of CCs may be asymmetric with respect to downlink and uplink (e.g., more or fewer CCs may be allocated for downlink than for uplink).

The CCs may include a primary CC and one or more secondary CCs. A primary CC may be referred to as a primary cell (PCell) and each secondary CC may be referred to as a secondary cell (SCell). The PCell may also be referred to as a “serving cell” when the UE is known both to a network device at the access network level and to at least one core network entity (e.g., AMF and/or MME) at the core network level, and the UE may be configured to receive downlink control information in the access network (e.g., the UE may be in an RRC Connected state). In some instances, in which carrier aggregation is configured for the UE, each of the PCell and the one or more SCells may be a serving cell.

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mm Wave” or simply “mmW”) band in documents and articles, despite being different from the extremely high frequency (EHF) band (30 GHz-300 GHz) which is identified by the International Telecommunications Union (ITU) as a “millimeter wave” band. In some aspects, “mmW” or “near-mmW” may additionally or alternatively refer to a 60 GHz frequency range, which may include multiple channels outside of 60 GHz. For example, a 60 GHz frequency band may refer to a set of channels spanning from 57.24 GHz to 70.2 GHz.

In view of the foregoing, unless specifically stated otherwise, the term “sub-6 GHz,” “sub-7 GHz,” and the like, to the extent used herein, may broadly represent frequencies that may be less than 6 GHz, frequencies that may be less than 7 GHz, frequencies that may be within FR1, and/or frequencies that may include mid-band frequencies. Further, unless specifically stated otherwise, the term “millimeter wave” and other similar references, to the extent used herein, may broadly represent frequencies that may include mid-band frequencies, frequencies that may be within FR2, and/or frequencies that may be within the EHF band.

A network device 102 may be implemented as a macro network device providing a large cell or may be implemented as a small cell 102′ having a small cell coverage area. Some network devices 102 may operate in a traditional sub-6 GHz (or sub-7 GHz) spectrum, in mmW frequencies, and/or near-mmW frequencies in communication with the UE 104. When such a network device operates in mmW or near-mmW frequencies, the network device may be referred to as a mmW network device 180. The mmW network device 180 may utilize beamforming 186 with the UE 104 to compensate for the path loss and short range. The network device 180 and the UE 104 may each include a plurality of antennas, such as antenna elements, antenna panels, and/or antenna arrays to facilitate the beamforming.

The network device 180 may transmit a beamformed signal to the UE 104 in one or more transmit directions 182. The UE 104 may receive the beamformed signal from the network device 180 in one or more receive directions 184. The UE 104 may also transmit a beamformed signal to the network device 180 in one or more transmit directions. The network device 180 may receive the beamformed signal from the UE 104 in one or more receive directions. One or both of the network device 180 and/or the UE 104 may perform beam training to determine the best receive and/or transmit directions for the one or both of the network device 180 and/or UE 104. The transmit and receive directions for the network device 180 may or may not be the same. The transmit and receive directions for the UE 104 may or may not be the same.

In various different aspects, one or more of the network devices 102/180 may include and/or be referred to as a gNB, Node B, eNB, an access point, a base transceiver station, a radio network device, a radio transceiver, a transceiver function, a basic service set (BSS), an extended service set (ESS), a transmit reception point (TRP), or some other suitable terminology.

In some aspects, one or more of the network devices 102/180 may be connected to the EPC 160 and may provide respective access points to the EPC 160 for one or more of the UEs 104. The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, with the Serving Gateway 166 being connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the network devices 102 belonging to a Multicast Broadcast Single Frequency Network (MBSFN) area broadcasting a particular service, and may be responsible for session management (start/stop) and for collecting eMBMS related charging information.

In some other aspects, one or more of the network devices 102/180 may be connected to the core network 190 and may provide respective access points to the core network 190 for one or more of the UEs 104. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, network device, or a network equipment, such as a BS, or one or more units (or one or more components) performing network device functionality, may be implemented in an aggregated or disaggregated architecture. For example, a BS (such as a Node B (NB), eNB, NR BS, 5G NB, access point (AP), a TRP, or a cell, etc.) may be implemented as an aggregated network device (also known as a standalone BS or a monolithic BS) or a disaggregated network device.

An aggregated network device may be configured to utilize a radio protocol stack that is physically or logically integrated within a single RAN node. A disaggregated network device 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also can be implemented as virtual units, i.e., a virtual central unit (VCU), a virtual distributed unit (VDU), or a virtual radio unit (VRU).

Network device-type operation or network design may consider aggregation characteristics of network device functionality. For example, disaggregated network devices may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated network device, or disaggregated RAN architecture, can be configured for wired or wireless communication with at least one other unit.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Referring back to FIG. 1A, in certain aspects, the UE 104 may include a resource optimization component 198 that is configured to receive a Sidelink Control Information 2 (SCI2) indicating resource mapping for a Physical Sidelink Shared Channel (PSSCH) transmission. The resource optimization component 198 may also be configured to identify a first transmitting Demodulation Reference Signal (DMRS) symbol associated with the received PSSCH transmission. The resource optimization component 198 may further be configured to de-map the SCI2 starting from the first transmitted DMRS symbol per resource block. Furthermore, the resource optimization component 198 may be configured to skip one or more RBs in the SCI2 mapping. The skipped RBs being identified as those subject to channel estimation impairments due to extrapolation.

Referring back to FIG. 1A, in certain aspects, the UE 104 may include a resource optimization component 198 that is configured to generate a Sidelink Control Information 2 (SCI2) indicating resource mapping for a Physical Sidelink Shared Channel (PSSCH) transmission. The resource optimization component 198 may also be configured to determine a first transmitting Demodulation Reference Signal (DMRS) symbol associated with the PSSCH transmission. The resource optimization component 198 may further be configured to map the SCI2 starting from the first transmitted DMRS symbol per resource block for the transmission. Furthermore, the resource optimization component 198 may be configured to skipping one or more RBs in the SCI2 mapping. The skipped RBs being identified as those subject to channel estimation impairments due to extrapolation.

FIG. 1B shows a diagram illustrating an example disaggregated network device 181 architecture. The disaggregated network device 181 architecture may include one or more CUs 183 that can communicate directly with core network 190 via a backhaul link, or indirectly with the core network 190 through one or more disaggregated network device units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUS 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 can be logically split into one or more CU-UP units and one or more CU-CP units. The CU-UP unit can communicate bidirectionally with the CU-CP unit via an interface, such as the E1 interface when implemented in an O-RAN configuration. The CU 183 can be implemented to communicate with the DU 185, as necessary, for network control and signaling.

The DU 185 may correspond to a logical unit that includes one or more network device functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) can be implemented with an interface configured to communicate signals with other layers (and modules) hosted by the DU 185, or with the control functions hosted by the CU 183.

Lower-layer functionality can be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 can be implemented to handle over the air (OTA) communication with one or more UEs 104. In some implementations, real-time and non-real-time aspects of control and user plane communication with the RU(s) 187 can be controlled by the corresponding DU 185. In some scenarios, this configuration can enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements can include, but are not limited to, CUs 183, DUs 185, RUs 187 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

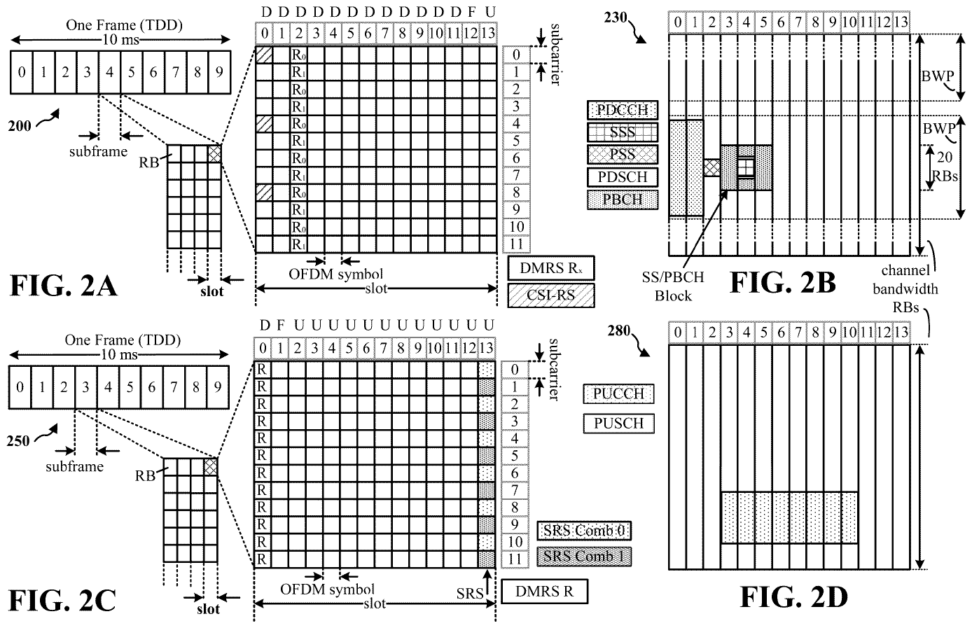

FIG. 2A is a diagram illustrating an example of a first subframe 200 within a 5G NR frame structure. FIG. 2B is a diagram illustrating an example of downlink channels within a 5G NR subframe 230. FIG. 2C is a diagram illustrating an example of a second subframe 250 within a 5G NR frame structure. FIG. 2D is a diagram illustrating an example of uplink channels within a 5G NR subframe 280. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 2A and 2C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry at least one pilot signal, such as a reference signal (RS), for the UE. Broadly, RSs may be used for beam training and management, tracking and positioning, channel estimation, and/or other such purposes. In some configurations, an RS may include at least one demodulation RS (DM-RS) (indicated as Rx for one particular configuration, where 100× is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 2B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. A UE (such as a UE 104 of FIG. 1A) may use the PSS to determine subframe/symbol timing and a physical layer identity. A secondary synchronization signal (SSS) may be within symbol 4 of particular subframes of a frame. A UE (such as a UE 104 of FIG. 1A) may use the SSS to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the network device. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a network device for channel quality estimation to enable frequency-dependent scheduling on the uplink.

FIG. 2D illustrates an example of various uplink channels within a subframe of a frame. The PUCCH may be located as indicated in one configuration. The PUCCH carries uplink control information (UCI), which may include a scheduling request (SR), a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

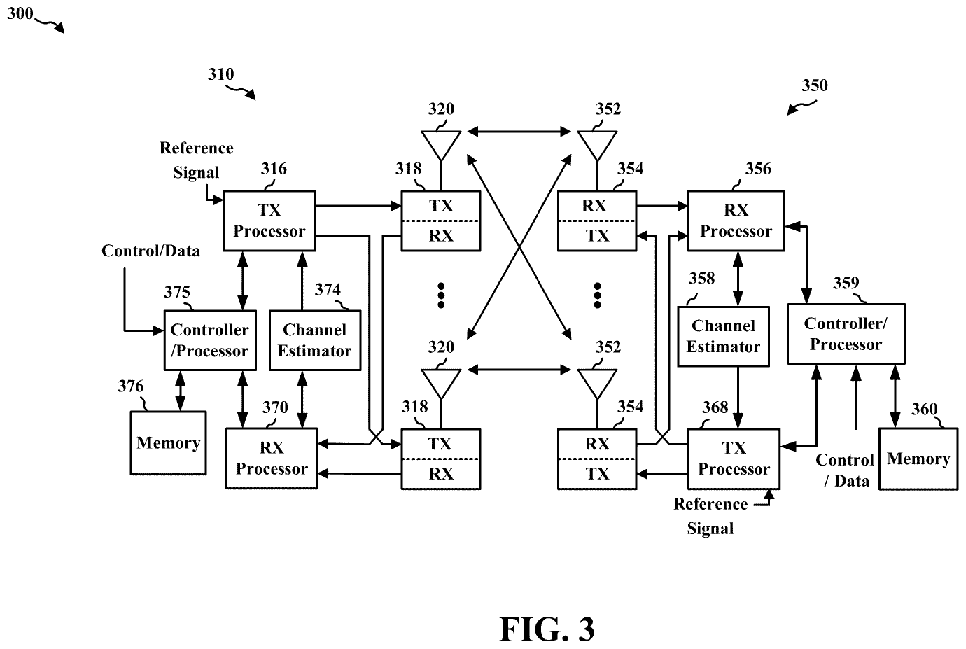

FIG. 3 is a block diagram of a network device 310 in communication with a UE 350 in an access network 300. In the downlink, IP packets from the EPC 160 may be provided to a controller/processor 375. The controller/processor 375 implements Layer 2 (L2) and Layer 3 (L3) functionality. L3 includes an RRC layer, and L2 includes a service data adaptation protocol (SDAP) layer, a packet data convergence protocol (PDCP) layer, an RLC layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement Layer 1 (L1) functionality associated with various signal processing functions. L1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially pre-coded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate a radio frequency (RF) carrier with a respective spatial stream for transmission.

At the UE 350, each receiver 354RX receives a signal through at least one respective antenna 352. Each receiver 354RX recovers information modulated onto an RF carrier and provides the information to the receive (RX) processor 356. The TX processor 368 and the RX processor 356 implement L1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the network device 310. These soft decisions may be based on channel estimates computed by the channel estimator 358. The soft decisions are then decoded and deinterleaved to recover the data and control signals that were originally transmitted by the network device 310 on the physical channel. The data and control signals are then provided to the controller/processor 359, which implements L3 and L2 functionality.

The controller/processor 359 can be associated with a memory 360 that stores program codes and data. The memory 360 may be referred to as a computer-readable medium. In the uplink, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the downlink transmission by the network device 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the network device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The uplink transmission is processed at the network device 310 in a manner similar to that described in connection with the receiver function at the UE 350. Each receiver 318RX receives a signal through at least one respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the uplink, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the coverage extension component 198 of FIG. 1A.

At least one of the TX processor 368, the RX processor 356, and the controller/processor 359 may be configured to perform aspects in connection with the coverage extension component 199 of FIG. 1A.

In NR SL, control data is divided between the PSCCH and the PSSCH. Specifically, NR SL SCI1 is transmitted via PSCCH, while NR SL SCI2 is transmitted through PSSCH. Since SCI2 is essential for determining whether data is addressed to the receiving UE and how it should be decoded, it must be more robust than the data itself. This requirement has led to the design of SCI2 with a lower, more manageable code rate relative to the data. SCI2 is mapped from the first DMRS symbol—practically carrying pilots—with the frequency dimension prioritized first, followed by the symbol dimension. This design ensures robust channel estimation for SCI2 while also minimizing decoding latency.

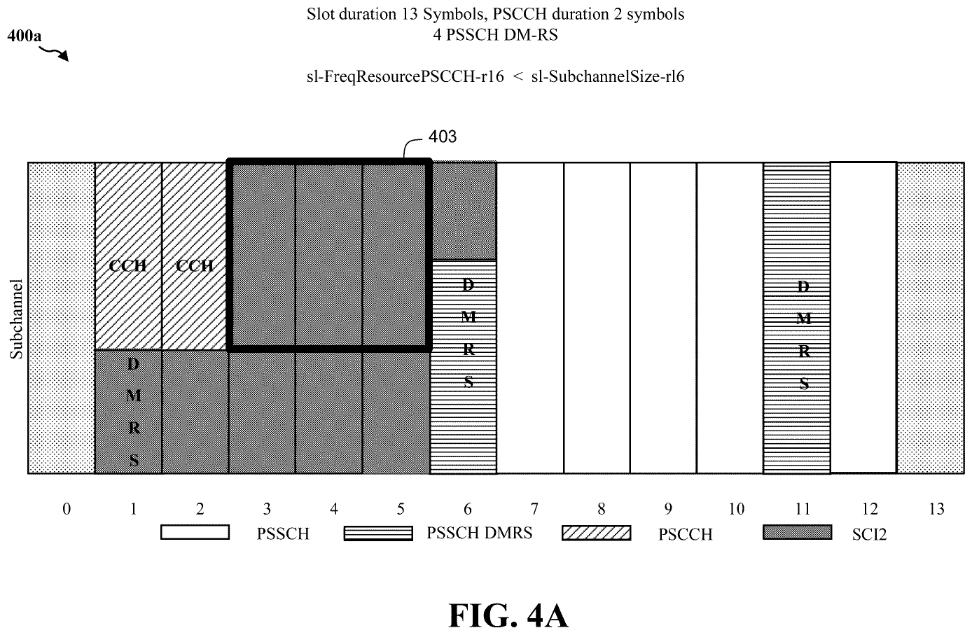

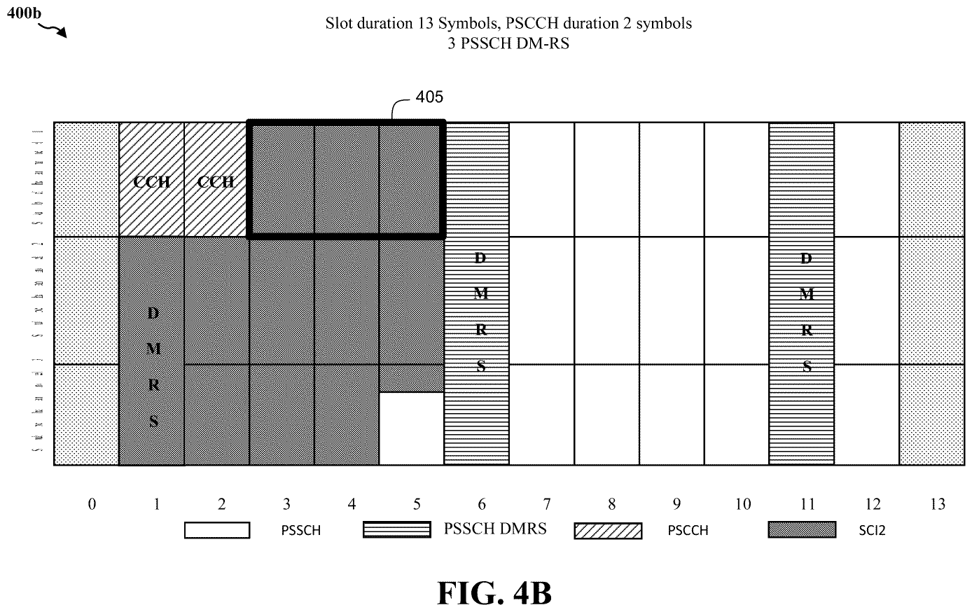

SCI2 can operate under three possible configurations in the frequency domain, each impacting its time-domain allocation. In the first configuration, the PSSCH allocation and PSCCH configuration use the same number of RBs. In the second configuration, the PSSCH allocation is larger than the PSCCH configuration, which can occur in two ways: (Configuration 2A) the subchannel resource pool configuration is larger than the PSCCH configuration within the same resource pool, as will be described below in FIG. 4A, or (Configuration 2B) the PSSCH is spread across multiple subchannels, independent of the PSCCH configuration, as will be described below in FIG. 4B. The first configuration is not being addressed in the present disclosure.

Due to the presence of the PSCCH block, there may be “missing” or “partial” DMRS in the first subchannel. This can result in the need to extrapolate channel estimation for one or more symbol resources within that subchannel, potentially leading to degraded performance for the SCI2 mapped to those resources, as observed in cases 2A and 2B. The extent of this degradation depends on several factors, including the RRC configuration—specifically the PSCCH and PSSCH settings—as well as the real-time frequency domain resource assignment and DMRS configuration transmitted by the sending device.

FIG. 4A illustrates a first configuration 400a (e.g., Configuration 2A) where the PSSCH allocation is larger than PSCCH configuration. Specifically, the first configuration 400a shows a scenario where Sub Channel size in the RRC configuration of the resource pool (sl-SubchannelSize-r16) is larger than PSCCH number of RBs (sl-FreqResourcePSCCH-r16).

When the PSSCH allocation consists of a single SubChannel, then the SCI2 begins in the first PSSCH DMRS symbol carrying pilots. This leads to degraded performance in specific areas 403, where channel estimation will be based on extrapolation and not interpolation as in all the rest of the RBs, reducing the robustness of SCI2 decoding. Accordingly, SCI2 mapping onto such suboptimal resources (e.g., specific areas 403) impacts the robustness of SCI2, which is crucial for determining data decoding. Since SCI2 is essential for accurate data reception, its improper mapping results in higher decoding errors.

In addition, in scenarios where the PSSCH allocation consists of multiple consecutive SubChannels, the issue persists, affecting accurate data reception. Accordingly, the first configuration 400a demonstrates that improper SCI2 mapping in these conditions significantly impacts channel estimation and reduces the reliability of NR sidelink communication. Furthermore, SCI2 placement is still affected even when the PSSCH allocation is single channel.

FIG. 4B illustrates a second configuration 400b (e.g., Configuration 2B) where PSSCH is spread over multiple SubChannels, irrespective of the PSCCH configuration. Specifically, the second configuration 400b shows a scenario where the PSSCH allocation received in the frequency domain resource assignment (e.g., inside the SCI payload) consists of multiple consecutive SubChannels. For example, FIG. 4B shows three SubChannels in specific areas 405.

When the PSSCH allocation consists of a single SubChannel and then the SCI2 will start in the first PSSCH DMRS symbol carrying pilots. Similar to FIG. 4A, this also leads to degraded performance in the specific areas 405, where channel estimation will be based on extrapolation and not interpolation as in all the rest of the RBs, reducing the robustness of SCI2 decoding. Accordingly, SCI2 mapping onto such suboptimal resources (e.g., specific areas 405) also impacts the robustness of SCI2 and results in higher decoding errors. Thus, the second configuration 400b also demonstrates that improper SCI2 mapping in these conditions significantly impacts channel estimation and reduces the reliability of NR sidelink communication.

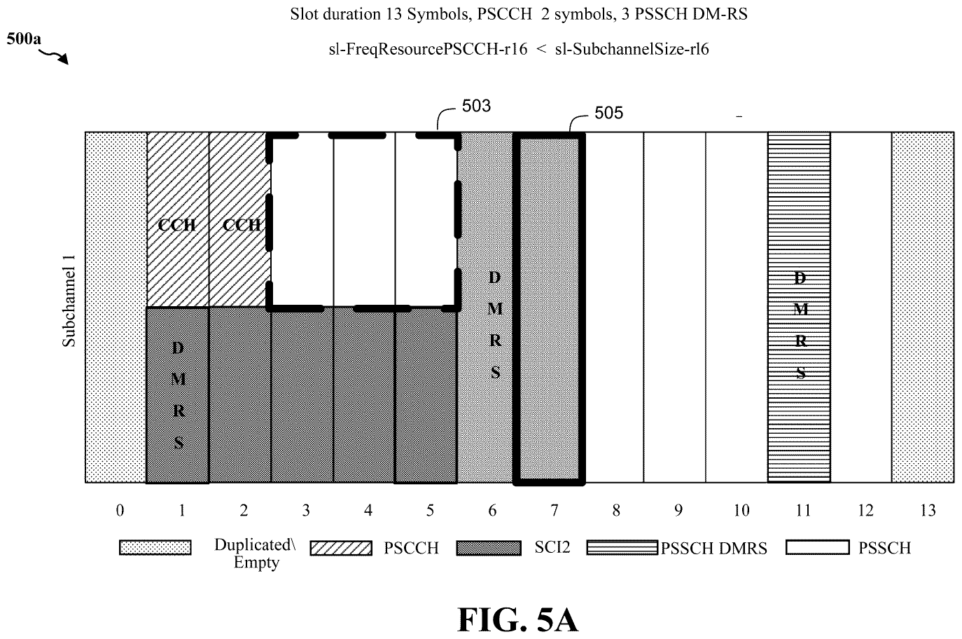

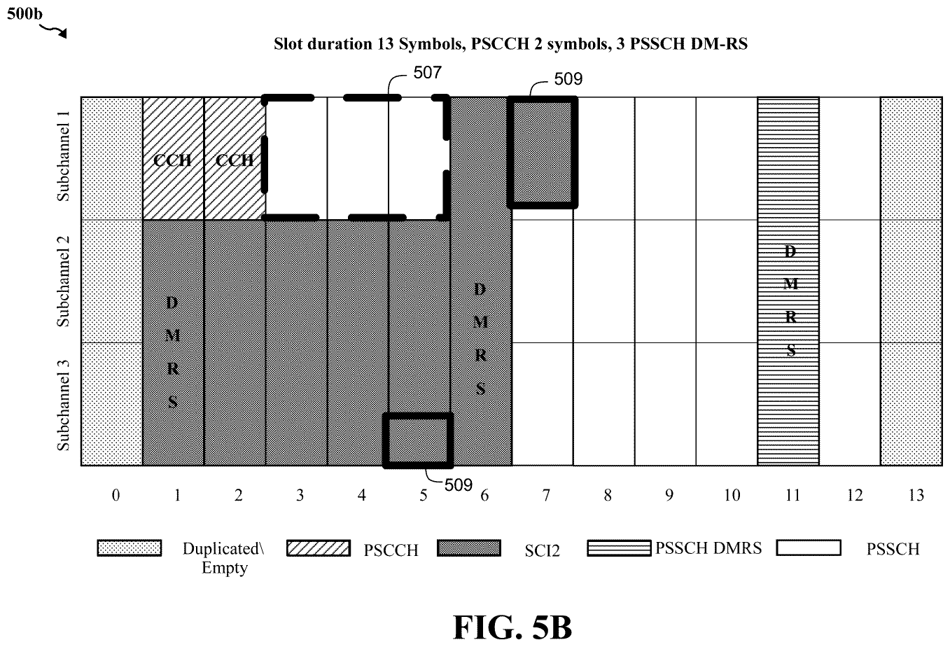

FIG. 5A illustrates an example of allocation mapping in the first configuration 500a (e.g., Configuration 2A). As opposed to FIG. 4A, the mapping of SCI2 can be such that it skips resources (e.g., specific area 503) which are more susceptible to channel estimation impairments such as extrapolation. Instead, the SCI2 mapping will start at the first transmitted PSSCH DMRS symbol 505 per RB-rather than at the first PSSCH DMRS symbol carrying pilots as shown in FIG. 4A.

FIG. 5B illustrates an example of allocation mapping in the second configuration 500b (e.g., Configuration 2B). As opposed to FIG. 5A, the mapping of SCI2 can also be such that it skips resources (e.g., specific area 507) which are susceptible to channel estimation impairments. Instead, the SCI mapping will also start at the first transmitted PSSCH DMRS symbol 509 per RB rather than at the first PSSCH DMRS symbol carrying pilots as shown in FIG. 4B.

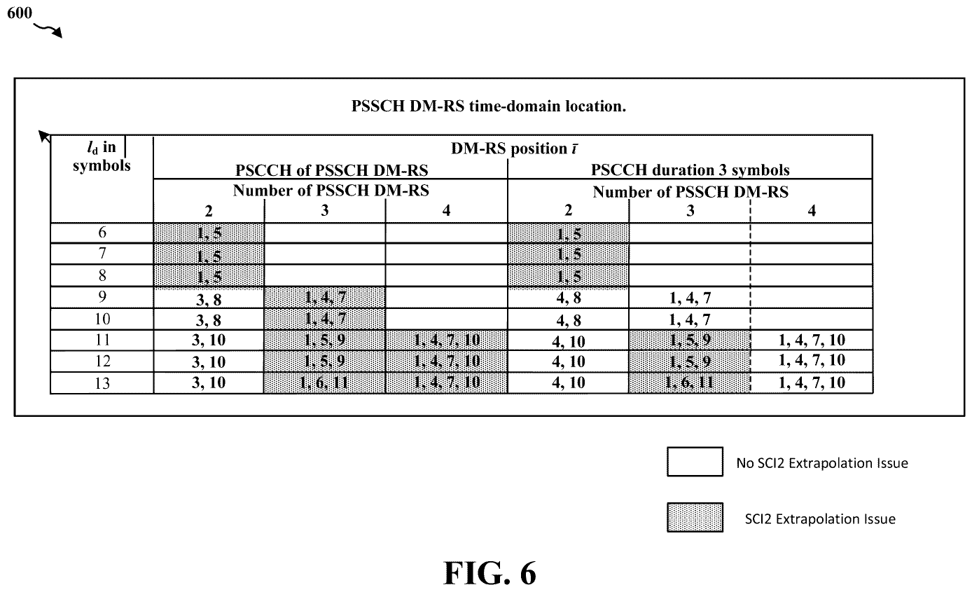

FIG. 6 illustrates a table showing various parameter configurations where SCI2 extrapolation becomes problematic. Example 600 shows a table specifying the time-domain location of the Physical Subcarrier Channel De-Modulation Reference Signal (PSSCH DM-RS) based on the Physical Signaling Subcarrier Channel (PSCCH) duration. For example, the table specifies where the PSSCH DM-RS is placed within the time domain based on the PSCCH duration. The PSSCH duration can be either two or three symbols, which influences the placement of the PSSCH DM-RS.

As shown in example 600, the table outlines various parameters suffer from the issue where SCI2 mapping onto certain resources can result in degraded performance due to channel estimation impairments, particularly when relying on extrapolation rather than interpolation. Specifically, the extrapolation problem arises in specific cases where the PSSCH allocation and the PSSCH configuration differ in size, leading to SCI2 being mapped to suboptimal resource elements. The parameter configurations that cause a SCI2 extrapolation issue are shown as a dotted pattern and the parameter configurations that do not cause a SCI2 extrapolation are shown as having no patterns. This demonstrates that the SCI2 extrapolation issue occurs frequently rather than being a rare corner case.

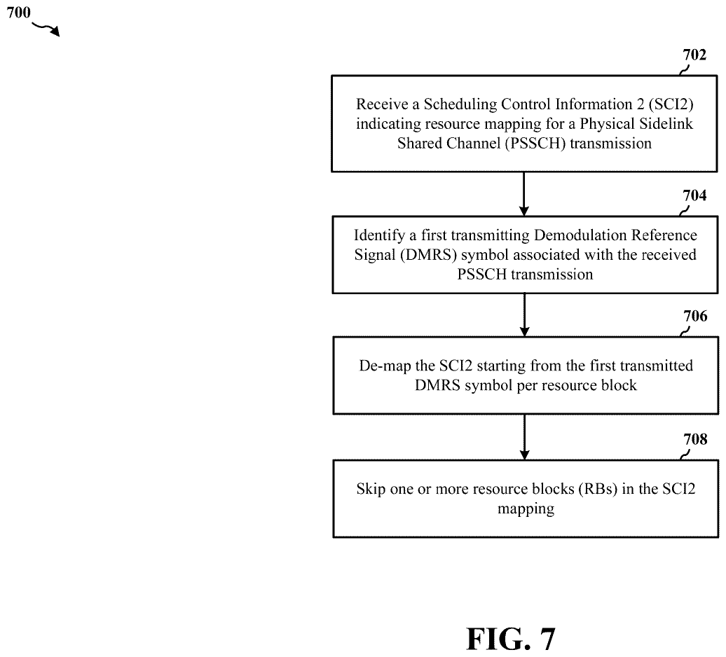

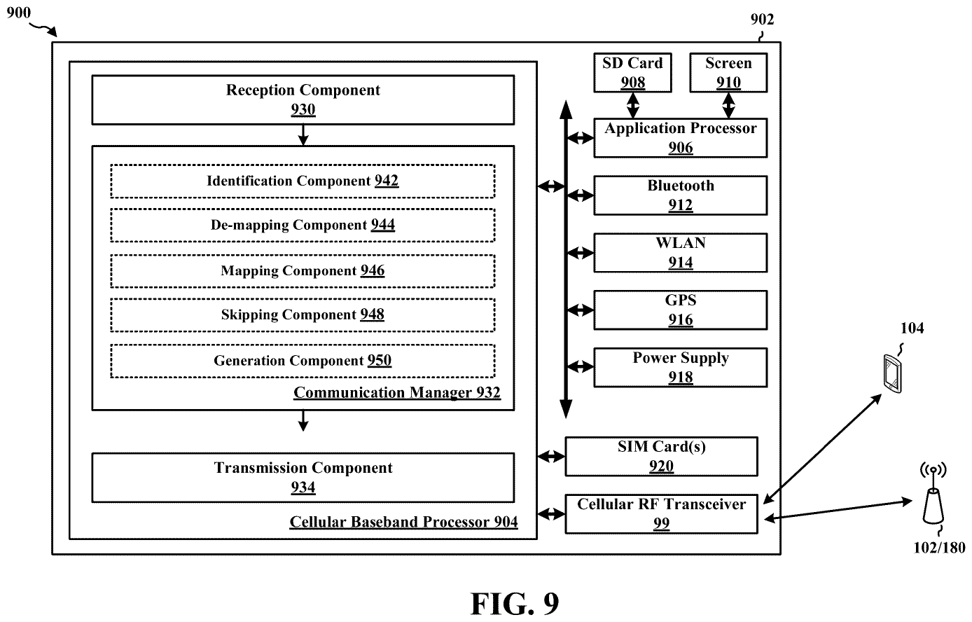

FIG. 7 is a flowchart of a method 700 of wireless communication. The method may be performed by a UE (e.g., the UE 104; the apparatus 902 shown in FIG. 9). Specifically, the method may be performed by one or more memories, processors, and RF front ends (e.g., the memory 360, controller/processor 359, transmitter 354TX, receiver 354RX, antenna 352, etc. of FIG. 3). Optional aspects are illustrated with a dashed line. The method 700 corresponds to a method of wireless communication performed by a Rx device.

At 702, the UE may receive a SCI2 indicating resource mapping for a PSSCH transmission. This step is used in NR sidelink communication, where devices communicate directly without a base station. SCI2 serves as the second stage of sidelink control information, helping the receiving UE determine how to decode and where the data is mapped within the allocated resources. The mapping details ensure that the SCI2 transmission is robust and optimally placed to minimize errors, improve decoding accuracy, and maintain efficient channel estimation. Proper resource allocation through SCI2 helps mitigate performance issues, such as extrapolation-based channel estimation, which can degrade the signal reliability. For example, 702 may be performed by the reception component 930 of the apparatus 902 of FIG. 9.

In some aspects, the SCI2 mapping may correspond to a first scenario (Configuration 2A shown in FIG. 5A) comprising a PSSCH allocation having a larger number of RBs than a PSCCH configuration. As shown in FIG. 5A, this scenario arises when the subchannel resource pool configuration exceeds the RB allocation for the PSCCH, leading to potential implications for SCI2 robustness. Specifically, the difference in resource allocation may result in channel estimation challenges, particularly in areas where SCI2 mapping relies on extrapolation rather than interpolation. Such conditions can degrade SCI2 decoding performance, necessitating strategies to mitigate potential robustness issues in sidelink communication systems.

In some aspects, the SCI2 mapping may correspond to a second scenario (Configuration 2B shown in FIG. 5B) comprising a PSSCH allocation case spanning multiple subchannels. As shown in FIG. 5B, the PSSCH resources are distributed across multiple subchannels, irrespective of the PSCCH configuration. This distribution can introduce challenges in SCI2 decoding, particularly in areas where channel estimation relies on extrapolation rather than interpolation, potentially reducing the reliability of the SCI2 transmission. The scattered allocation of PSSCH may impact the effectiveness of SCI2 mapping, necessitating refined allocation strategies to enhance robustness and mitigate performance degradation in sidelink communication.

At 704, the UE may identify a first transmitting DMRS symbol associated with the received PSSCH transmission. This identification is used for accurate channel estimation, as the DMRS serves as a reference point for decoding the transmitted data. By determining the initial DMRS symbol, the UE can effectively synchronize with the transmission and improve its ability to interpret the subsequent SCI2 mapping. This process helps ensure reliable communication by enhancing signal robustness, minimizing decoding errors, and optimizing the overall performance of the sidelink transmission. For example, 704 may be performed by the identification component 942 of the apparatus 902 of FIG. 9.

At 706, the UE may de-map the SCI2 starting from the first transmitted DMRS symbol per RB. This approach ensures that the SCI2 decoding process aligns with the reference signal structure of the received PSSCH transmission, facilitating accurate channel estimation. By using the first DMRS symbol as a starting point, the UE can extract the SCI2 information in a manner that minimizes the impact of channel estimation errors, particularly in challenging propagation conditions. This method enhances the robustness of SCI2 decoding by leveraging interpolation-based estimation rather than extrapolation, thereby improving the overall reliability of sidelink communication. For example, 706 may be performed by the de-mapping component 944 of the apparatus 902 of FIG. 9.

At 708, the UE may skip one or more RBs in the SCI2 mapping, wherein the skipped RBs are identified as those subject to channel estimation impairments due to extrapolation. This is designed to enhance the reliability of SCI2 decoding by avoiding RBs where the channel estimation is less accurate. Extrapolation-based estimation can introduce errors due to its reliance on incomplete or less reliable reference data, potentially degrading the performance of the SCI2 transmission. By selectively omitting such RBs from the SCI2 mapping, the UE can focus on RBs where interpolation-based estimation is more effective, leading to improved signal quality and more robust sidelink communication. This adaptive mapping approach optimizes SCI2 decoding, reducing the likelihood of errors and ensuring more reliable data transmission in challenging network conditions. As an example, as shown in FIG. 5A, the one or more RBs susceptible to channel estimation impairments due to extrapolation are shown in the specific areas 503. As another example, as shown in FIG. 5B, the one or more RBs susceptible to channel estimation impairments due to extrapolation are shown in the specific areas 507. For example, 708 may be performed by the skipping component 948 of the apparatus 902 of FIG. 9.

In some aspects, the skipped one or more RBs may be identified based on being positioned in a region of a resource grid utilizing extrapolation for channel estimation. Extrapolation-based estimation occurs when there is insufficient reference information, making it less accurate compared to interpolation, which leverages surrounding data points. RBs in such regions are more susceptible to estimation errors, leading to degraded SCI2 decoding performance. By detecting these RBs and excluding them from SCI2 mapping, the system enhances reliability and minimizes the risk of decoding errors. This selective skipping approach ensures that SCI2 is mapped onto more stable regions of the grid (e.g., rather than regions that are susceptible to channel estimation impairments due to extrapolation), improving overall robustness and efficiency in sidelink communication.

In some aspects, the UE may determine the skipped one or more RBs based on configuration parameters received from a network node or on pre-configured configuration parameters received from the transmitting UE. This process plays a role in optimizing the robustness of SCI2 transmission by preventing mapping onto RBs that are prone to channel estimation errors, such as those requiring extrapolation. The skipping mechanism ensures that SCI2 is placed in resource elements where interpolation can be effectively applied, thereby improving decoding accuracy and reducing performance degradation. The UE can rely on pre-configured settings or dynamic configurations received in real time to make this determination, ensuring adaptability to varying network conditions and transmission scenarios. By implementing such an approach, the overall reliability and efficiency of SCI2 transmission in NR Sidelink communication are significantly enhanced, as demonstrated in performance evaluations where skipping problematic RBs led to a notable improvement in SCI2 decoding performance.

In some aspects, the configuration parameters comprise at least a sidelink resource pool configuration and/or a real-time frequency domain resource assignment. The sidelink resource pool configuration, typically defined in the RRC signaling, provides a structured allocation of resources for sidelink communication, ensuring that SCI2 mapping aligns with predefined parameters that optimize performance. On the other hand, real-time frequency domain resource assignment, conveyed dynamically by the transmitting UE, allows adaptive adjustments based on the current channel conditions and transmission requirements. By leveraging both static and dynamic configurations, the system can ensure that SCI2 is mapped to RBs with optimal channel conditions, thereby reducing the risk of channel estimation errors due to extrapolation. This approach enhances the robustness and reliability of SCI2 decoding, particularly in scenarios where varying sidelink allocations or interference patterns may otherwise degrade performance.

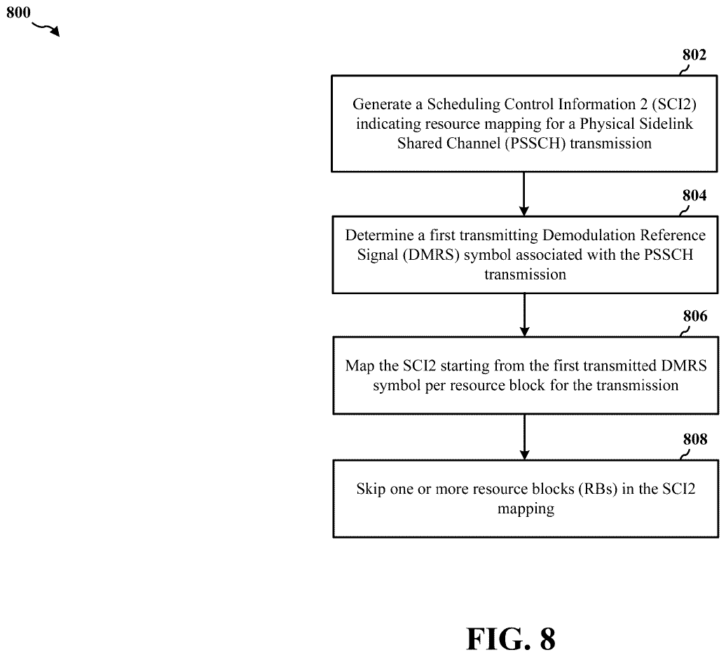

FIG. 8 is a flowchart of a method 800 of wireless communication. The method may be performed by a UE (e.g., the UE 104; the apparatus 902 shown in FIG. 9). Specifically, the method may be performed by one or more memories, processors, and RF front ends (e.g., the memory 360, controller/processor 359, transmitter 354TX, receiver 354RX, antenna 352, etc. of FIG. 3). Optional aspects are illustrated with a dashed line. The method 800 corresponds to a method of wireless communication performed by a Tx device.

At 802, the UE may generate a SCI2 indicating resource mapping for a PSSCH transmission. This process is used for ensuring that the receiving UE can correctly interpret and decode the transmitted data. The SCI2 message includes details on how PSSCH resources are allocated, specifying which RBs are used for data transmission and ensuring alignment with the sidelink resource pool configuration and real-time frequency domain resource assignment. By encoding this information, the UE enables efficient channel estimation and decoding while also allowing for optimizations such as skipping RBs that are prone to channel estimation impairments. This approach enhances the robustness of sidelink communication by improving the accuracy of resource allocation and reducing potential errors in PSSCH decoding, ultimately leading to more reliable data transmission between UEs. For example, 802 may be performed by the generation component 950 of the apparatus 902 of FIG. 9.

In some aspects, the SCI2 mapping may correspond to a first scenario comprising a PSSCH allocation having a larger number of RBs than a PSCCH configuration. As shown in FIG. 5A, this scenario arises when the subchannel resource pool configuration exceeds the RB allocation for the PSCCH, leading to potential implications for SCI2 robustness. Specifically, the difference in resource allocation may result in channel estimation challenges, particularly in areas where SCI2 mapping relies on extrapolation rather than interpolation. Such conditions can degrade SCI2 decoding performance, necessitating strategies to mitigate potential robustness issues in sidelink communication systems.

In some aspects, the SCI2 mapping may correspond to a second scenario comprising a PSSCH allocation case spanning multiple subchannels. As shown in FIG. 5B, the PSSCH resources are distributed across multiple subchannels, irrespective of the PSCCH configuration. This distribution can introduce challenges in SCI2 decoding, particularly in areas where channel estimation relies on extrapolation rather than interpolation, potentially reducing the reliability of the SCI2 transmission. The scattered allocation of PSSCH may impact the effectiveness of SCI2 mapping, necessitating refined allocation strategies to enhance robustness and mitigate performance degradation in sidelink communication.

At 804, the UE may determine a first transmitting Demodulation Reference Signal (DMRS) symbol associated with the PSSCH transmission. The DMRS symbols serve as pilot signals that enable the receiving UE to estimate the channel conditions and accurately demodulate the transmitted data. Identifying the first DMRS symbol is crucial, as it provides a reference point for channel estimation and influences how SCI2 is mapped within the PSSCH transmission. By aligning SCI2 mapping with the first DMRS symbol, the UE can ensure that control information is placed in RBs where channel estimation is most reliable, reducing dependency on extrapolation. This strategic alignment enhances decoding performance, improving the robustness of SCI2 and overall sidelink communication by mitigating potential impairments due to channel variation. For example, 804 may be performed by the identification component 942 of the apparatus 902 of FIG. 9.

At 806, the UE may map the SCI2 starting from the first transmitted DMRS symbol per RB for the transmission. This mapping strategy ensures that SCI2 is placed in time-frequency resources where channel estimation is most reliable, minimizing the risk of decoding errors. By anchoring SCI2 to the first DMRS symbol, the UE optimizes the use of pilot signals for accurate channel estimation, reducing the reliance on extrapolation, which can degrade performance. This approach enhances the robustness of SCI2 transmission by ensuring that control information is positioned in areas of the resource grid with strong reference signals, ultimately leading to improved decoding accuracy and more reliable sidelink communication. For example, 806 may be performed by the mapping component 946 of the apparatus 902 of FIG. 9.

At 808, the UE may skip one or more RBs in the SCI2 mapping, wherein the skipped RBs are identified as those subject to channel estimation impairments due to extrapolation. Extrapolation occurs when RBs lack sufficient reference points from DMRS symbols, leading to inaccurate channel estimation and increased decoding errors. By proactively avoiding these RBs, the UE ensures that SCI2 is placed in regions where interpolation can be used for more accurate channel estimation. This strategic allocation enhances the robustness of SCI2 transmission, reducing the likelihood of corrupted control information and improving overall sidelink communication reliability. The skipping mechanism, based on either predefined configurations and/or real-time frequency domain resource assignments, optimizes resource utilization while mitigating the negative impact of poor channel condition. As an example, as shown in FIG. 5A, the one or more RBs susceptible to channel estimation impairments due to extrapolation are shown in the specific areas 503. As another example, as shown in FIG. 5B, the one or more RBs susceptible to channel estimation impairments due to extrapolation are shown in the specific areas 507. For example, 806 may be performed by the skipping component 948 of the apparatus 902 of FIG. 9.

In some aspects, the skipped one or more RBs may be identified based on being positioned in a region of a resource grid utilizing extrapolation for channel estimation. Extrapolation occurs when an RB is too far from a DMRS symbol, making channel estimation less reliable and increasing the likelihood of decoding errors. To mitigate this issue, the UE determines which RBs fall into these susceptible regions and excludes them from SCI2 mapping. This ensures that SCI2 is placed in resource elements where interpolation-based estimation can be applied, resulting in improved decoding accuracy and overall robustness of sidelink communication. By intelligently skipping these RBs, the system enhances the reliability of control information transmission and reduces performance degradation caused by poor channel estimation.

In some aspects, the UE may determine the skipped one or more RBs based on configuration parameters received from a network node or on pre-configured configuration parameters received from the transmitting UE. These parameters define sidelink resource allocation strategies and account for potential channel estimation impairments that may arise due to extrapolation. By leveraging network-provided configurations, the UE can dynamically adapt to changing transmission conditions, ensuring that SCI2 is mapped onto RBs with reliable channel estimation. Alternatively, when operating in direct communication without network assistance, the UE can rely on pre-configured settings from the transmitting device to optimize SCI2 placement. This approach enhances sidelink communication robustness by preventing SCI2 transmission in RBs where decoding errors are more likely, thereby improving overall reliability and efficiency.

In some aspects, the configuration parameters comprise at least a sidelink resource pool configuration and/or a real-time frequency domain resource assignment. The sidelink resource pool configuration, typically provided through RRC signaling, defines the allocated resources available for sidelink communication, ensuring that SCI2 placement aligns with predefined network parameters. Meanwhile, the real-time frequency domain resource assignment, sent dynamically by the transmitting UE, allows for adaptive adjustments based on current channel conditions. By considering both static and dynamic configuration parameters, the UE can effectively determine which RBs may be susceptible to channel estimation impairments and optimize SCI2 placement accordingly. This intelligent mapping strategy improves channel estimation accuracy, enhances the robustness of SCI2 decoding, and ultimately leads to more reliable sidelink communication.

FIG. 9 is a diagram 900 illustrating an example of a hardware implementation for an apparatus 902. The apparatus 902 may be a UE (the UE 104, 350) or similar device, or the apparatus 902 may be a component of a UE or similar device. The apparatus 902 may include a cellular baseband processor 904 (also referred to as a modem) and/or a cellular RF transceiver 922, which may be coupled together and/or integrated into the same package, component, circuit, chip, and/or other circuitry.

In some aspects, the apparatus 902 may accept or may include one or more subscriber identity modules (SIM) cards 920, which may include one or more integrated circuits, chips, or similar circuitry, and which may be removable or embedded. The one or more SIM cards 920 may carry identification and/or authentication information, such as an international mobile subscriber identity (IMSI) and/or IMSI-related key(s). Further, the apparatus 902 may include one or more of an application processor 906 coupled to a secure digital (SD) card 908 and a screen 910, a Bluetooth module 912, a wireless local area network (WLAN) module 914, a Global Positioning System (GPS) module 916, and/or a power supply 918.

The cellular baseband processor 904 communicates through the cellular RF transceiver 922 with the UE 104, 350 and/or network device 102/180. The cellular baseband processor 904 may include a computer-readable medium/memory. The computer-readable medium/memory may be non-transitory. The cellular baseband processor 904 is responsible for general processing, including the execution of software stored on the computer-readable medium/memory. The software, when executed by the cellular baseband processor 904, causes the cellular baseband processor 904 to perform the various functions described supra. The computer-readable medium / memory may also be used for storing data that is manipulated by the cellular baseband processor 904 when executing software. The cellular baseband processor 904 further includes a PHR component 940, an adjustment component 942, and a reporting component 944. The communication manager 932 includes the one or more illustrated components. The components within the communication manager 932 may be stored in the computer-readable medium/memory and/or configured as hardware within the cellular baseband processor 904.

In the context of FIG. 3, the cellular baseband processor 904 may be a component of the UE 350 and may include the memory 360 and/or at least one of the TX processor 368, the RX processor 356, and/or the controller/processor 359. In one configuration, the apparatus 902 may be a modem chip and/or may be implemented as the cellular baseband processor 904, while in another configuration, the apparatus 902 may be the entire UE (e.g., the UE 350 of FIG. 3) and may include some or all of the abovementioned components, circuits, chips, and/or other circuitry illustrated in the context of the apparatus 902. In one configuration, the cellular RF transceiver 922 may be implemented as at least one of the transmitter 354TX and/or the receiver 354RX.

The reception component 930 may be configured to receive signaling on a wireless channel, such as signaling from a network device 102/180 or UE 104. The transmission component 934 may be configured to transmit signaling on a wireless channel, such as signaling to a network device 102/180 or UE 104. The communication manager 932 may coordinate or manage some or all wireless communications by the apparatus 902, including across the reception component 930 and the transmission component 934.

The reception component 930 may provide some or all data and/or control information included in received signaling to the communication manager 932, and the communication manager 932 may generate and provide some or all of the data and/or control information to be included in transmitted signaling to the transmission component 934. The communication manager 932 may include the various illustrated components, including one or more components configured to process received data and/or control information, and/or one or more components configured to generate data and/or control information for transmission.

The communication manager 932 includes an identification component 942 that is configured to identify a first transmitting Demodulation Reference Signal (DMRS) symbol associated with the received PSSCH transmission, e.g., as described in connection with operation 704 from FIG. 7.

In some aspects, the communication manager 932 also includes a de-mapping component 944 that is configured to de-map the SCI2 starting from the first transmitted DMRS symbol per RB, e.g., as described in connection with operation 706 from FIG. 7.

In some aspects, the communication manager 932 also includes a mapping component 946 that is configured to map the SCI2 starting from the first transmitted DMRS symbol per resource block for the transmission, e.g., as described in connection with operation 806 from FIG. 8.

In some aspects, the communication manager 932 also includes a skipping component 948 configured to skip one or more RBs in the SCI2 mapping, wherein the skipped RBs are identified as those subject to channel estimation impairments due to extrapolation, e.g., as described n connection with paragraph 708 from FIG. 7 and paragraph 808 from FIG. 8.

In some aspects, the communication manager 932 also includes a generation component 950 configured to generate a Sidelink Control Information 2 (SCI2) indicating resource mapping for a Physical Sidelink Shared Channel (PSSCH) transmission, e.g., as described in connection with paragraph 802 from FIG. 8.

The apparatus 902 may include additional components that perform some or all of the blocks, operations, signaling, etc. of the algorithm(s) in the aforementioned call flow diagram(s) and/or flowchart(s) of FIGS. 7-8. As such, some or all of the blocks, operations, signaling, etc. in the aforementioned call flow diagram(s) and/or flowchart(s) of FIGS. 7-8 may be performed by one or more components and the apparatus 902 may include one or more such components. The components may be one or more hardware components specifically configured to carry out the stated processes/algorithm, implemented by a processor configured to perform the stated processes/algorithm, stored within a computer-readable medium for implementation by a processor, or some combination thereof.

The aforementioned means may be one or more of the aforementioned components of the apparatus 902 configured to perform the functions recited by the aforementioned means. As described supra, the apparatus 902 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order and are not meant to be limited to the specific order or hierarchy presented.

### Some Additional Examples

The following examples are illustrative only and may be combined with aspects of other embodiments or teachings described herein, without limitation.

Clause 1. A method of wireless communication performed by a first user equipment (UE), comprising: receiving a Sidelink Control Information 2 (SCI2) indicating resource mapping for a Physical Sidelink Shared Channel (PSSCH) transmission; identifying a first transmitting Demodulation Reference Signal (DMRS) symbol associated with the received PSSCH transmission; de-mapping the SCI2 starting from the first transmitted DMRS symbol per resource block (RB); and skipping one or more RBs in the SCI2 mapping, wherein the skipped RBs are identified as those subject to channel estimation impairments due to extrapolation.

Clause 2. The method of clause 1, wherein the skipped one or more RBs are identified based on being positioned in a region of a resource grid utilizing extrapolation for channel estimation.

Clause 3. The method of any of the clauses 1 to 2, wherein the UE determines the skipped one or more RBs based on configuration parameters received from a network node or on pre-configured configuration parameters received from the transmitting UE.

Clause 4. The method of any of the clauses 1 to 3, wherein the configuration parameters comprise at least a sidelink resource pool configuration and/or a real-time frequency domain resource assignment.

Clause 5. The method of any of the clauses 1 to 4, wherein the UE corresponds to a receiver UE.

Clause 6. The method of any of the clauses 1 to 5, wherein the SCI2 mapping corresponds to a first scenario comprising a PSSCH allocation having a larger number of RBs than a PSCCH configuration.

Clause 7. The method of any of the clauses 1 to 6, wherein the SCI2 mapping corresponds to a second scenario comprising a PSSCH allocation case spanning multiple subchannels.

Clause 8. A method of wireless communication performed by a second user equipment (UE), comprising: generating a Sidelink Control Information 2 (SCI2) indicating resource mapping for a Physical Sidelink Shared Channel (PSSCH) transmission; determining a first transmitting Demodulation Reference Signal (DMRS) symbol associated with the PSSCH transmission; mapping the SCI2 starting from the first transmitted DMRS symbol per resource block for the transmission; and skipping one or more RBs in the SCI2 mapping, wherein the skipped RBs are identified as those subject to channel estimation impairments due to extrapolation.

Clause 9. The method of clause 8, wherein the skipped one or more RBs are identified based on being positioned in a region of a resource grid using extrapolation for channel estimation.

Clause 10. The method of any of the clauses 8 to 9, wherein the UE determines the skipped one or more RBs based on configuration parameters received from a network node or on pre-configured configuration parameters from the transmitting UE.

Clause 11. The method of any of the clauses 8 to 10, wherein the configuration parameters comprise at least a sidelink resource pool configuration and/or a real-time frequency domain resource assignment.

Clause 12. The method of any of the clauses 8 to 11, wherein the UE corresponds to a transmitter UE.

Clause 13. The method of any of the clauses 8 to 12, wherein the SCI2 mapping corresponds to a first scenario comprising a PSSCH allocation having a larger number of RBs than a PSCCH configuration.

Clause 14. The method of any of the clauses 8 to 13, wherein the SCI2 mapping corresponds to a second scenario comprising a PSSCH allocation case spanning multiple subchannels.

Clause 15. An apparatus for wireless communication at a user equipment (UE), comprising: at least one memory; and at least one processor coupled to the at least one memory and, based at least in part on information stored in the at least one memory, the at least one processor, individually or in combination, is configured to cause the UE to: receive a Sidelink Control Information 2 (SCI2) indicating resource mapping for a Physical Sidelink Shared Channel (PSSCH) transmission; identify a first transmitting Demodulation Reference Signal (DMRS) symbol associated with the received PSSCH transmission; de-map the SCI2 starting from the first transmitted DMRS symbol per resource block; and skip one or more RBs in the SCI2 mapping, wherein the skipped RBs are identified as those subject to channel estimation impairments due to extrapolation.

Clause 16. The apparatus of clause 15, wherein the skipped one or more RBs are identified based on being positioned in a region of a resource grid utilizing extrapolation for channel estimation.

Clause 17. The apparatus of any of the clauses 15 to 16, wherein the UE corresponds to a receiver UE.

Clause 18. The apparatus of any of the clauses 15 to 17, wherein the configuration parameters comprise at least a sidelink resource pool configuration and/or a real-time frequency domain resource assignment.

Clause 19. The apparatus of any of the clauses 15 to 18, wherein the identification of the skipped RBs is based on a distance from the DMRS symbol in a time-frequency resource grid.

Clause 20. The apparatus of any of the clauses 15 to 19, wherein the SCI2 mapping corresponds to a first scenario comprising a PSSCH allocation having a larger number of RBs than a PSCCH configuration.

The following examples are illustrative only and may be combined with aspects of other embodiments or teachings described herein, without limitation.

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication performed by a first user equipment (UE) using Sidelink or Device-to-Device (D2D), comprising:
receiving a Sidelink Control Information 2 (SCI2) indicating resource mapping for a Physical Sidelink Shared Channel (PSSCH) transmission;
identifying a first transmitting Demodulation Reference Signal (DMRS) symbol associated with the received PSSCH transmission;
de-mapping the SCI2 starting from the first transmitted DMRS symbol per resource block (RB); and
skipping one or more RBs in the SCI2 mapping, wherein the skipped RBs are identified as those subject to channel estimation impairments due to extrapolation.

2. The method of claim 1, wherein the skipped one or more RBs are identified based on being positioned in a region of a resource grid utilizing extrapolation for channel estimation.

3. The method of claim 1, wherein the UE determines the skipped one or more RBs based on configuration parameters received from a network node or on pre-configured configuration parameters received from the transmitting UE.

4. The method of claim 3, wherein the configuration parameters comprise at least a sidelink resource pool configuration and/or a real-time frequency domain resource assignment.

5. The method of claim 1, wherein the first UE corresponds to a receiver UE.

6. The method of claim 1, wherein the SCI2 mapping corresponds to a first scenario comprising a PSSCH allocation having a larger number of RBs than a PSCCH configuration.

7. The method of claim 1, wherein the SCI2 mapping corresponds to a second scenario comprising a PSSCH allocation case spanning multiple subchannels.

8. A method of wireless communication performed by a second user equipment (UE) using Sidelink or Device-to-Device (D2D), comprising:
generating a Sidelink Control Information 2 (SCI2) indicating resource mapping for a Physical Sidelink Shared Channel (PSSCH) transmission;
determining a first transmitting Demodulation Reference Signal (DMRS) symbol associated with the PSSCH transmission;
mapping the SCI2 starting from the first transmitted DMRS symbol per resource block for the transmission; and
skipping one or more RBs in the SCI2 mapping, wherein the skipped RBs are identified as those subject to channel estimation impairments due to extrapolation.

9. The method of claim 8, wherein the skipped one or more RBs are identified based on being positioned in a region of a resource grid using extrapolation for channel estimation.

10. The method of claim 8, wherein the UE determines the skipped one or more RBs based on configuration parameters received from a network node or on pre-configured configuration parameters from the transmitting UE.

11. The method of claim 10, wherein the configuration parameters comprise at least a sidelink resource pool configuration and/or a real-time frequency domain resource assignment.

12. The method of claim 8, wherein the second UE corresponds to a transmission UE.

13. The method of claim 8, wherein the SCI2 mapping corresponds to a first scenario comprising a PSSCH allocation having a larger number of RBs than a PSCCH configuration.

14. The method of claim 8, wherein the SCI2 mapping corresponds to a second scenario comprising a PSSCH allocation case spanning multiple subchannels.

15. An apparatus for wireless communication at a user equipment (UE) using Sidelink or Device-to-Device (D2D), comprising:
at least one memory; and
at least one processor coupled to the at least one memory and, based at least in part on information stored in the at least one memory, the at least one processor, individually or in combination, is configured to cause the UE to:
receive a Sidelink Control Information 2 (SCI2) indicating resource mapping for a Physical Sidelink Shared Channel (PSSCH) transmission;
identify a first transmitting Demodulation Reference Signal (DMRS) symbol associated with the received PSSCH transmission;
de-map the SCI2 starting from the first transmitted DMRS symbol per resource block; and
skip one or more RBs in the SCI2 mapping, wherein the skipped RBs are identified as those subject to channel estimation impairments due to extrapolation.

16. The apparatus of claim 15, wherein the skipped one or more RBs are identified based on being positioned in a region of a resource grid utilizing extrapolation for channel estimation.

17. The apparatus of claim 15, wherein the UE determines the skipped one or more RBs based on configuration parameters received from a network node or on pre-configured configuration parameters from the transmitting UE.

18. The apparatus of claim 17, wherein the configuration parameters comprise at least a sidelink resource pool configuration and/or a real-time frequency domain resource assignment.

19. The apparatus of claim 15, wherein the UE corresponds to a receiver UE.

20. The apparatus of claim 15, wherein the SCI2 mapping corresponds to a first scenario comprising a PSSCH allocation having a larger number of RBs than a PSCCH configuration.
